(19) United States
(12) Patent Application Publication
(10) Pub. No.: US 2013/0113962 A1
(43) Pub. Date: May 9, 2013

(54) IMAGE PROCESSING METHOD FOR PRODUCING BACKGROUND BLURRED IMAGE AND IMAGE CAPTURING DEVICE THEREOF

(71) Applicant: Yun-Chin Li, New Taipei City (TW)

(72) Inventor: Yun-Chin Li, New Taipei City (TW)

(73) Assignee: ALTEK CORPORATION, Hsinchu City (TW)

(21) Appl. No.: 13/334,093

(22) Filed: Dec. 22, 2011

(30) Foreign Application Priority Data
Nov. 3, 2011 (TW) 100140167

(51) Int. Cl. H04N 5/262

(52) U.S. Cl. 348/240.2; 348/239; 348/E05.055

(57) ABSTRACT

An image processing method for producing background blurred image and an image capturing device thereof are provided. The image processing method for producing background blurred image includes following steps. First, a plurality of live-view images are continuously captured on a subject and a target image is captured. Next, a geometric correction on the live-view images is performed so as to produce a plurality of corrected live-view images. Then, a correlation comparison on the corrected live-view images is performed so as to produce a relative depth of field (DOF) map. Further, the relative DOF map is enlarged. Finally, a subject area containing a subject in the target image is determined according to the enlarged relative DOF map and a blurring processing on a remained area except for the subject area is performed so as to produce a background blurred image.

### CROSS-REFERENCE TO RELATED APPLICATION

This application claims the priority benefit of Taiwan application serial no. 100140167, filed on Nov. 3, 2011. The entirety of the above-mentioned patent application is hereby incorporated by reference herein and made a part of this specification.

### BACKGROUND OF THE INVENTION

1. Field of the Invention

The invention generally relates to an image processing method and an image capturing device thereof, and more particularly, to an image processing method for producing background blurred image and an image capturing device thereof.

2. Description of Related Art

Along with progress of optical technology, cameras with adjustable aperture and shutter, even with replaceable lenses, are gradually popularized, and cameras tend to have a variety of function as well. While shooting an image by using a camera, a shooting skill so-called shallow depth of field (DOF) effect is usually adopted in order to emphasize the subject in the image. Namely, objects within a shooting distance are clearly imaged, while objects outside of the shooting distance are gradually blurred, in which the distance between a camera lens and a subject plane is the shooting distance.

However, the shallow DOF effect produced by a general camera lens is quite limited. At the time, in order to obtain a better shallow DOF effect, a large aperture lens is needed to enhance the blurring effect of the objects with a far distance, and the clearly imaged subject would stand out in a background. The large aperture lens is bulky and costs a lot of money, and a general consumer camera is unlikely equipped with such lens.

Another method to achieve the above-mentioned effect is to produce images with different blurry or clear extents by changing the camera shooting parameter. For example, a series of continuous shootings on a same scene are performed with different focal lengths so as to respectively locate the position of each pixel with the most clear image among all the shot images and further to deduct the relative DOF of every pixel in the image by using the relationship between focal length and DOF. The method however requires the user to properly control the camera shooting parameter so as to effectively estimate the relative DOFs and thereby produce a shallow DOF image with clear subject and blurry background, which indeed is difficult for most users to adjust and control the camera shooting parameter.

### SUMMARY OF THE INVENTION

Accordingly, the invention is directed to an image processing method for producing background blurred image and an image capturing device thereof, which captures a plurality of images without changing the camera shooting parameters, determines a subject area and further produces a shallow DOF image with clear subject and blurry background.

The invention provides an image processing method for producing background blurred image applied to an image capturing device. The image processing method for producing background blurred image includes following steps. First, a plurality of live-view images are continuously captured on a subject and a target image is captured. Next, a geometric correction on the live-view images is performed to produce a plurality of corrected live-view images. Preferably, the geometric correction can be a geometric alignment process. Then, a correlation comparison on the corrected live-view images is performed to produce a relative depth map. Further, the relative depth map is enlarged. Finally, a subject area containing a subject in the target image is determined according to the enlarged relative depth map and a blurring processing on a remained area except for the subject area in the target image is performed to produce a background blurred image.

In an embodiment of the present invention, the above-mentioned step of performing correlation comparison on the corrected live-view images to produce the relative depth map includes performing correlation comparison on each pixel of the corrected live-view images with a mask to generate a plurality of different correlations; and assigning different values according to the different correlations to produce the relative depth map.

In an embodiment of the present invention, the resolution of the above-mentioned live-view images is lower than the resolution of the target image.

In an embodiment of the present invention, prior to the step of enlarging the relative depth map, the method further includes reducing a resolution of the target image to generate a reduced target image, and the resolution of the reduced target image is the same as the resolution of the live-view images.

In an embodiment of the present invention, prior to the step of enlarging the relative depth map, the method further includes performing geometric correction on the reduced target image and one of the live-view images to make the corrected live-view images align with the reduced target image, and generate a geometric correction parameter.

In an embodiment of the present invention, prior to the step of enlarging the relative depth map, the method further includes performing geometric correction on the relative depth map according to the geometric correction parameter to produce a corrected relative depth map.

In an embodiment of the present invention, the above-mentioned step of enlarging the relative depth map includes enlarging the corrected relative depth map so that the resolution of the enlarged relative depth map is the same as the resolution of the target image.

The invention also provides an image capturing device for producing background blurred image, the device includes a capturing module, a geometric correction module, a processing unit and a zooming module. The capturing module herein is configured for continuously capturing a plurality of live-view images and capturing a target image, in which the resolution of the live-view images is lower than the resolution of the target image. The geometric correction module herein is coupled to the capturing module and performs a geometric correction on the live-view images to produce a plurality of corrected live-view images. The processing unit herein is coupled to the geometric correction module and performs a correlation comparison on the corrected live-view images to produce a relative depth map. The zooming module is coupled to the processing unit and receives and enlarges the relative depth map produced by the processing unit, in which the processing unit determines a subject area containing the subject in the target image according to the relative depth map after being enlarged by the zooming module and the processing unit performs a blurring processing on a remained area except for the subject area in the target image to produce a background blurred image.

In an embodiment of the present invention, the above-mentioned processing unit performs correlation comparison on each pixel of the corrected live-view images with a mask to generate a plurality of different correlations and assigns different values according to the different correlations to produce the relative depth map.

In an embodiment of the present invention, the above-mentioned zooming module further reduces a resolution of the target image to generate a reduced target image, in which the resolution of the reduced target image is the same as the resolution of live-view images, and the zooming module sends the reduced target image to the geometric correction module.

In an embodiment of the present invention, the above-mentioned geometric correction module performs a geometric correction on the reduced target image and one of the live-view images to make the corrected live-view images align with the reduced target image and generate a geometric correction parameter. The geometric correction module further performs a geometric correction on the relative depth map according to the geometric correction parameter so as to produce a corrected relative depth map.

In an embodiment of the present invention, the above-mentioned zooming module enlarges the corrected relative depth map so that the resolution of the enlarged relative depth map is the same as the resolution of the target image.

The invention also provides an image capturing device for producing background blurred image, comprising: means for continuously capturing a plurality of live-view images and capturing a target image, in which a resolution of the live-view images is lower than a resolution of the target image; means for performing geometric correction on the live-view images to produce a plurality of corrected live-view images; means for performing correlation comparison on the corrected live-view images to produce a relative depth map; means for enlarging the relative depth map; and means for determining a subject area containing the subject in the target image according to the relative depth map and performing blurring processing on a remained area except for the subject area in the target image to produce a background blurred image.

In an embodiment of the present invention, the above-mentioned means for enlarging the relative depth map comprises implementing a bilateral interpolation method or a bilinear interpolation method to enlarge the relative depth map.

In an embodiment of the present invention, the above-mentioned means for performing blurring processing comprises implementing a spatial filter, a linear filter, a non-linear filter or a blurring filter to produce the background blurred image.

Based on the above description, by using the image processing method for producing background blurred image and the image capturing device thereof, the invention can determine a subject area through capturing a plurality of low-resolution images without changing the camera shooting parameters and can perform a blurring processing on a remained area except for the subject area so as to further produce a shallow DOF image with clear subject and blurry background.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a flowchart of an image processing method for producing background blurred image according to an embodiment of the invention.

FIG. 2 is a schematic block diagram of an image capturing device for producing background blurred image according to an embodiment of the invention.

FIG. 3 is a flowchart of an image processing method for producing background blurred image according to another embodiment of the invention.

### DESCRIPTION OF THE EMBODIMENTS

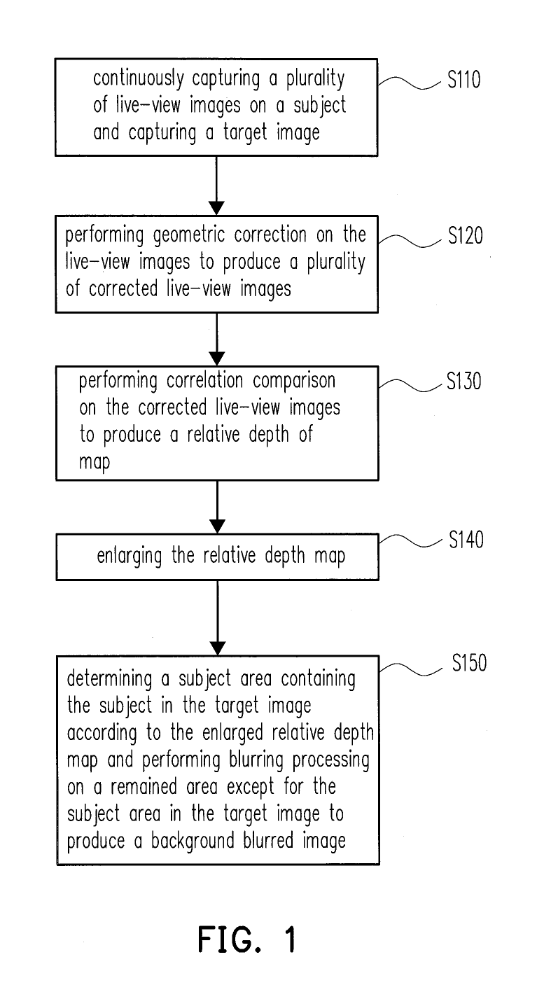

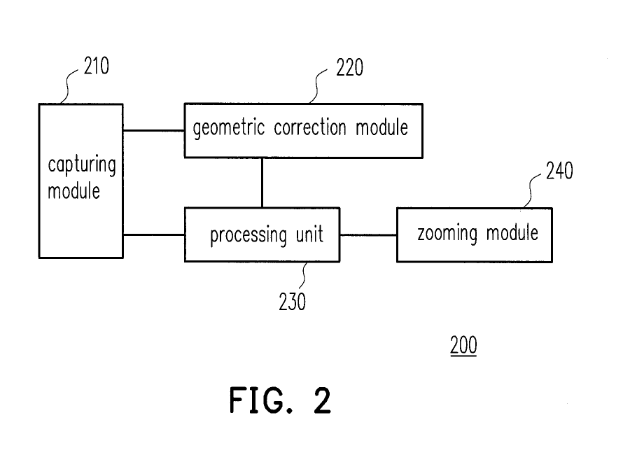

FIG. 1 is a flowchart of an image processing method for producing background blurred image according to an embodiment of the invention and FIG. 2 is a schematic block diagram of an image capturing device for producing background blurred image according to an embodiment of the invention. An image capturing device for producing background blurred image 200 is, for example, digital cameras, SLR (single lens reflex) cameras, digital video cameras or other smart phones and tablet PCs with image-capturing capabilities, etc., and they are not limited to the above. The image capturing device for producing background blurred image 200 includes a capturing module 210, a geometric correction module 220, a processing unit 230 and a zooming module 240. The above-mentioned modules can be implemented by hardware, software or a combination thereof. Below, the detailed steps of an image processing method for producing background blurred image of FIG. 1 will be explained with reference to various modules illustrated in FIG. 2.

First in step S110, the capturing module 210 continuously captures a plurality of live-view images and captures a target image on a subject. The live-view images are frames with low-resolution displayed on a display screen (not shown) of the image capturing device 200 after the image capturing device 200 is turned on and in live-view mode or in half shutter mode. When the image capturing device 200 is in full shutter mode, the captured image at the time is the above-mentioned target image. Therefore, the resolution of live-view images is lower than the resolution of the target image. It should be noted that, the number of the captured live-view images is not limited, which is set depending on the specification of the image capturing device 200, but usually the total time of continuously capturing the multiple live-view images by the image capturing device 200 is less than or equal to the time, required for capturing one target image.

Next in step S120, the geometric correction module 220 coupled to the capturing module 210 and the processing unit 230 performs a geometric correction on the live-view images to produce a plurality of corrected live-view images. Since the live-view images are obtained by a user to continuously shoot on a same subject, there may be shaking or moving occurred with the camera, so that it likely to shoot out images with different angles and different DOFs. However, the subject is still present in all the live-view images. The geometric correction module 220 is configured just for targeting the subjects and performing a geometric correction on the subject of each of the live-view images, so that the subjects of the corrected live-view images are located at a same position.

Then in step S130, the processing unit 230 receives the corrected live-view images produced by the geometric correction module 220 and performs correlation comparison on the corrected live-view images to produce a relative depth map. After the geometric correction, the subjects of the corrected live-view images are located at the same position, while the remaining objects in different distances from the subject thereof are not entirely aligned with each other due to the differences of the DOFs, so that it is needed to estimate the DOFs thereof by respectively using the differences between the corrected live-view images. In addition, there are also higher correlations for the subject areas containing subjects between the corrected live-view images, while there are lower correlations certainly for the remained areas except for the subject areas. The lower the correlation, the more far the shooting distance from the subject is; the higher the correlation, the more close the shooting distance from the subject is. Accordingly, the relative distance relationship between the subject and each object in the remained area except for the subject area can be respectively determined and decided according to the correlation. The above-mentioned correlations can be quantified to produce a relative depth map.

Thereafter in step S140, the zooming module 240 is coupled to the processing unit 230 and receives and enlarges the relative depth map produced by the processing unit 230 so that the resolution of the relative depth map is the same as the resolution of the target image. The enlarging method adopted by the zooming module 240 is, for example, bilateral interpolation, bilinear interpolation, etc. and they are not limited to the above.

Finally in step S150, the processing unit 230 determines a subject area containing the subject in the target image according to the enlarged relative depth map produced by the zooming module 240, in which the subject area represents each of the objects in the subject area has the same shooting distance as the subject's shooting distance. Therefore, the image in the subject area keeps the present clarity, while the processing unit 230 would perform a blurring processing on the remained area except for the subject area in the target image to produce an image with clear subject and blurry background, in which the blurring processing can be implemented by, for example, spatial filter, linear filter, non-linear filter or blurring filter, and they are not limited to the above.

Based on the above description, by using the relative depth map produced after performing the correlation comparison, the invention can determine a subject area and a remained area except for the subject area in the target image, and further can perform a blurring processing on the remained area except for the subject area. In this way, the user can use a plurality of continuously captured images by the camera to further produce a shallow DOF image with clear subject and blurry background without changing the camera shooting parameter.

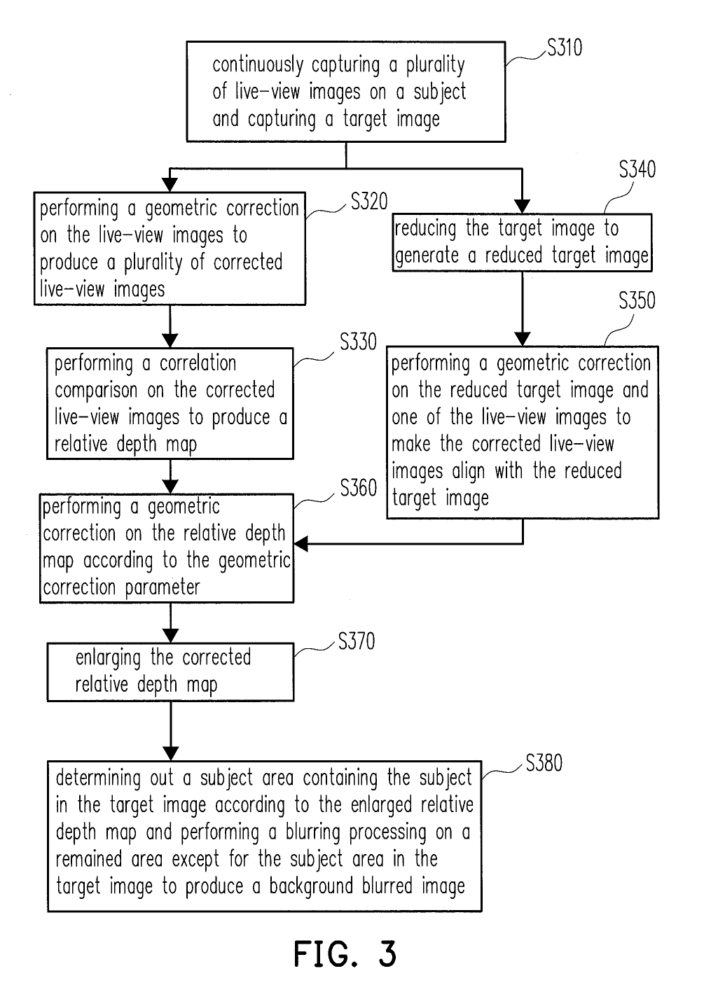

In order to better understand the invention, another embodiment serving as an exemplary embodiment for the invention to implement is explained. FIG. 3 is a flowchart of an image processing method for producing background blurred image according to another embodiment of the invention.

Referring to FIG. 3, the method includes following steps: first, continuously capturing a plurality of live-view images on a subject and capturing a target image (step S310); next, performing geometric correction on the live-view images to produce a plurality of corrected live-view images (step S320); then, performing correlation comparison on the corrected live-view images to produce a relative depth map, in which, in an embodiment for example, the first image of the corrected live-view images serves as a reference image, the correlation comparison with a mask is performed on each pixel of the reference image and each pixel of the remaining corrected live-view images correspondingly to generate a plurality of different correlations, and different values as a representation is assigned according to the different correlations, so that the relative depth map is produced and the user can, for example, make setting according to the real requirement where the correlations are divided into 10 classes ‘0’-‘10’, when the determined correlation is the highest class, it is represented by a value ‘10’ and when the determined correlation is the lowest class, it is represented by a value ‘0’, and thereby the relative depth map is produced (step S330).

Differently from the above-mentioned embodiment, in the present embodiment, prior to enlarging the relative depth map, the method further includes: reducing the target image to generate a reduced target image so that the resolution of the reduced target image is the same as the resolution of live-view images (step S340); and performing geometric correction on the reduced target image and one of the live-view images to make the corrected live-view images align with the reduced target image and generate geometric correction parameters (step S350). Since there is a time lag of capturing the target image and capturing the live-view images, image deviations may occur due to shaking or moving during the shooting period, so that the target image needs to be reduced and geometric correction is required to perform on the reduced target image and one of the live-view images to remove the image deviations.

Further, the method includes: performing geometric correction on the relative depth map according to the above-mentioned produced geometric correction parameter to produce a corrected relative DOF map (step S360). The relative depth map is produced according to the live-view images, in order to provide the relative depth map to the target image as the reference, the geometric correction parameters need to be adjusted so as to improve the precision of the reference.

Moreover, the method includes: enlarging the corrected relative depth map that the resolution of the enlarged relative depth map is the same as the resolution of the target image (step S370); determining a subject area containing the subject in the target image according to the enlarged relative depth map and performing a blurring processing on a remained area except for the subject area in the target image to produce a background blurred image (step S380). The other details in the flowchart of the embodiment can refer to the above-mentioned embodiment, which is omitted to describe.

In summary, the image processing method for producing background blurred image and the image capturing device thereof provided by the invention are able to use a plurality of continuously captured low-resolution images through performing a correlation comparison to determine information of a subject area and a non-subject area (i.e. the remained area except for the subject). Further a blurring processing on the non-subject area in the target image is performed by using the above-mentioned information to produce a shallow DOF image with clear subject and blurry background, which improves the image quality. In addition, the invention achieves the above-mentioned goal without relying on the large aperture lens and changing the camera shooting parameter for a series of continuously shootings, which increases the usage convenience for the consumers.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. An image processing method for producing background blurred image, which is applied to an image capturing device, comprising:
continuously capturing a plurality of live-view images on a subject and capturing a target image;
performing geometric correction on the live-view images to produce a plurality of corrected live-view images;
performing correlation comparison on the corrected live-view images to produce a relative depth map;
enlarging the relative depth map; and
determining a subject area containing the subject in the target image according to the enlarged relative depth map and performing blurring processing on a remained area except for the subject area in the target image to produce a background blurred image.

2. The image processing method for producing background blurred image as claimed in claim 1, wherein the step of performing correlation comparison on the corrected live-view images to produce the relative depth map comprises:
performing correlation comparison on each pixel of the corrected live-view images with a mask to generate a plurality of different correlations; and
assigning different values according to the different correlations to produce the relative depth map.

3. The image processing method for producing background blurred image as claimed in claim 1, wherein a resolution of the live-view images is lower than a resolution of the target image.

4. The image processing method for producing background blurred image as claimed in claim 1, wherein prior to the step of enlarging the relative depth map, the method further comprises:
reducing a resolution of the target image to generate a reduced target image, and the resolution of the reduced target image is the same as the resolution of the live-view images.

5. The image processing method for producing background blurred image as claimed in claim 4, wherein prior to the step of enlarging the relative depth map, the method further comprises:
performing geometric correction on the reduced target image and one of the live-view images to make the corrected live-view images align with the reduced target image, and generate a geometric correction parameter.

6. The image processing method for producing background blurred image as claimed in claim 5, wherein prior to the step of enlarging the relative depth map, the method further comprises:
performing geometric correction on the relative depth map according to the geometric correction parameter to produce a corrected relative depth map.

7. The image processing method for producing background blurred image as claimed in claim 6, wherein the step of enlarging the relative depth map comprises:
enlarging the corrected relative depth map so that a resolution of the enlarged relative depth map is the same as the resolution of the target image.

8. An image capturing device for producing background blurred image, comprising:
a capturing module, configured for continuously capturing a plurality of live-view images and capturing a target image, wherein a resolution of the live-view images is lower than a resolution of the target image;
a geometric correction module, coupled to the capturing module and performing geometric correction on the live-view images to produce a plurality of corrected live-view images;
a processing unit, coupled to the geometric correction module and performing correlation comparison on the corrected live-view images to produce a relative depth map; and
a zooming module, coupled to the processing unit and receiving and enlarging the relative depth map produced by the processing unit, wherein
the processing unit determines a subject area containing the subject in the target image according to the relative depth map after being enlarged by the zooming module and performs blurring processing on a remained area except for the subject area in the target image to produce a background blurred image.

9. The image capturing device for producing background blurred image as claimed in claim 8, wherein:
the processing unit performs correlation comparison on each pixel of the corrected live-view images with a mask to generate a plurality of different correlations and assigns different values according to the different correlations to produce the relative depth map.

10. The image capturing device for producing background blurred image as claimed in claim 8, wherein:
the zooming module further reduces a resolution of the target image to generate a reduced target image, wherein the resolution of the reduced target image is the same as the resolution of live-view images, and the zooming module sends the reduced target image to the geometric correction module.

11. The image capturing device for producing background blurred image as claimed in claim 10, wherein:
the geometric correction module performs geometric correction on the reduced target image and one of the live-view images to make the corrected live-view images align with the reduced target image and generate a geometric correction parameter, and the geometric correction module further performs geometric correction on the relative depth map according to the geometric correction parameter to produce a corrected relative depth map.

12. The image capturing device for producing background blurred image as claimed in claim 11, wherein the zooming module enlarges the corrected relative depth map so that a resolution of the enlarged relative depth map is the same as the resolution of the target image.

13. An image capturing device for producing background blurred image, comprising:
means for continuously capturing a plurality of live-view images and capturing a target image, wherein a resolution of the live-view images is lower than a resolution of the target image;
means for performing geometric correction on the live-view images to produce a plurality of corrected live-view images;
means for performing correlation comparison on the corrected live-view images to produce a relative depth map;
means for enlarging the relative depth map; and
means for determining a subject area containing the subject in the target image according to the relative depth map and performing blurring processing on a remained area except for the subject area in the target image to produce a background blurred image.

14. The image capturing device for producing background blurred image as claimed in claim 13, wherein the means for performing correlation comparison on the corrected live-view images to produce the relative depth map comprises:
means for performing correlation comparison on each pixel of the corrected live-view images with a mask to generate a plurality of different correlations and assigning different values according to the different correlations to produce the relative depth map.

15. The image capturing device for producing background blurred image as claimed in claim 13, wherein prior to the means for enlarging the relative depth map, further comprising:
means for reducing a resolution of the target image to generate a reduced target image, wherein the resolution of the reduced target image is the same as the resolution of the live-view images.

16. The image capturing device for producing background blurred image as claimed in claim 15, wherein prior to the means for prior to the means for enlarging the relative depth map, further comprising:
means for performing geometric correction on the reduced target image and one of the live-view images to make the corrected live-view images align with the reduced target image, and generating a geometric correction parameter.

17. The image capturing device for producing background blurred image as claimed in claim 16, wherein prior to the means for prior to the means for enlarging the relative depth map, further comprising:
means for performing geometric correction on the relative depth map according to the geometric correction parameter to produce a corrected relative depth map.

18. The image capturing device for producing background blurred image as claimed in claim 17, further comprising:
means for enlarging the corrected relative depth map so that a resolution of the enlarged relative depth map is the same as the resolution of the target image.

19. The image capturing device for producing background blurred image as claimed in claim 13, wherein the means for enlarging the relative depth map comprises implementing a bilateral interpolation method or a bilinear interpolation method to enlarge the relative depth map.

20. The image capturing device for producing background blurred image as claimed in claim 13, wherein the means for performing blurring processing comprises implementing a spatial filter, a linear filter, a non-linear filter or a blurring filter to produce the background blurred image.
